(19) United States
(12) Patent Application Publication
(10) Pub. No.: US 2007/0295783 A1
(43) Pub. Date: Dec. 27, 2007

(54) Multiple tip soldering with individually compliant tip

(75) Inventor: Andy C. Kotten, Burnsville, MN (US)

Correspondence Address: Fellers, Snider, Blankenship, Bailey & Tippens;Suite 1700, 100 North Broadway, Oklahoma City, OK, 73102-8820, US

(73) Assignee: Seagate Technology LLC, Scotts Valley, CA (US)

(21) Appl. No.: 11/475,714

(22) Filed: Jun. 27, 2006

(51) Int. Cl. A47J 36/02

(52) U.S. Cl. 228/101

(57) ABSTRACT

A multiple tip soldering tool is provided having a conductor adapted for conducting power from an external supply. The tool also has a segmented hot bar having first and second independent suspensions. Each suspension depends at a proximal end from the conductor and conductively supports a soldering tip at a distal end. A method is provided that includes providing a multiple tip soldering tool having a segmented hot bar providing a plurality of soldering tips supported by independent suspensions. The method also includes advancing the multiple tip soldering tool toward a plurality of connectors until one of the soldering tips contacts a respective connector, and then continuing to advance the multiple tip soldering tool until all of the soldering tips contact the respective connectors.

### FIELD OF THE INVENTION

The embodiments of the present invention relate generally to the field of soldering electrical connections and more particularly, but without limitation, to multiple tip soldering tools and associated methods.

### BACKGROUND

Electronic devices in general contain integrated electronics that are manufactured at a high throughput velocity. Soldering is a proven effective way of quickly and effectively making electrical connections between miniaturized components. For example, in data storage devices one such electrical connection occurs in connecting the leads of a flexible printed circuit from a transducer that is used in storing data to and retrieving data from a data storage medium. The leads are connected to a mating printed circuit board resident on an E block portion of an actuator that supports the transducer in movement across the storage medium.

Soldering the leads one at a time might optimize the quality of the connections, but such an approach is prohibitively expensive. Thus, technology has been applied to the development of devices and methodologies that can efficiently and effectively gang-solder a plurality of connections simultaneously. As components have become more and more miniaturized, however, part-to-part and process variations that were once considered negligible can now make the difference between a robust connection and a factory or field failure. Some sources of variation are related to misalignment between the soldering tool and the connections. Other sources of variation are related to varying solder pad heights, or printed circuit trace thicknesses, and the like. What is needed is a way to compensate for these randomly occurring variations to ensure that the soldering tool makes adequate contacting engagement so the requisite pressure and heat always gets to the connection. It is to these improvements that the embodiments of the present invention are directed.

### SUMMARY OF THE INVENTION

Embodiments of the present invention are generally directed to an apparatus and associated methodology for soldering multiple electrical connectors simultaneously.

In some embodiments a multiple tip soldering tool is provided having a conductor adapted for conducting power from an external supply. The tool also has a segmented hot bar having first and second independent suspensions. Each suspension depends at a proximal end from the conductor and conductively supports a soldering tip at a distal end.

In some embodiments a method is provided that includes providing a multiple tip soldering tool having a segmented hot bar providing a plurality of soldering tips supported by independent suspensions. The method also includes advancing the multiple tip soldering tool toward a plurality of connectors until one of the soldering tips contacts a respective connector. The method also includes continuing to advance the multiple tip soldering tool until all of the soldering tips contact the respective connectors.

In some embodiments a method is provided for electrically connecting components of a data storage device. The method includes attaching a transducer having a flex circuit to a distal end of an actuator. The method also includes attaching the flex circuit to a circuit portion supported by a proximal end of the actuator by steps for soldering the circuits together in electrical connection.

These and various other features and advantages which characterize the claimed invention will become apparent upon reading the following detailed description and upon reviewing the associated drawings.

### BRIEF DESCRIPTION OF THE DRAWINGS

FIG. 1 is an isometric view of a data storage device constructed in accordance with embodiments of the present invention.

FIG. 2 is a functional control schematic diagram of the data storage device of FIG. 1.

FIG. 3 is an isometric view of the actuator assembly of the data storage device of FIG. 1.

FIG. 4 is an enlarged diagrammatic view of portions of the actuator assembly of FIG. 3.

FIGS. 5-7 are diagrammatic illustrations of varying size solder pads as encountered by a related art fixed hot bar, a related art compliant hot bar, and a segmented hot bar of the present embodiments, respectively.

FIGS. 8-10 are isometric, side, and front views, respectively, of a multiple tip soldering tool constructed in accordance with embodiments of the present invention.

FIG. 11 is a flowchart of a method for MULTI-TIP SOLDERING in accordance with embodiments of the present invention.

### DETAILED DESCRIPTION

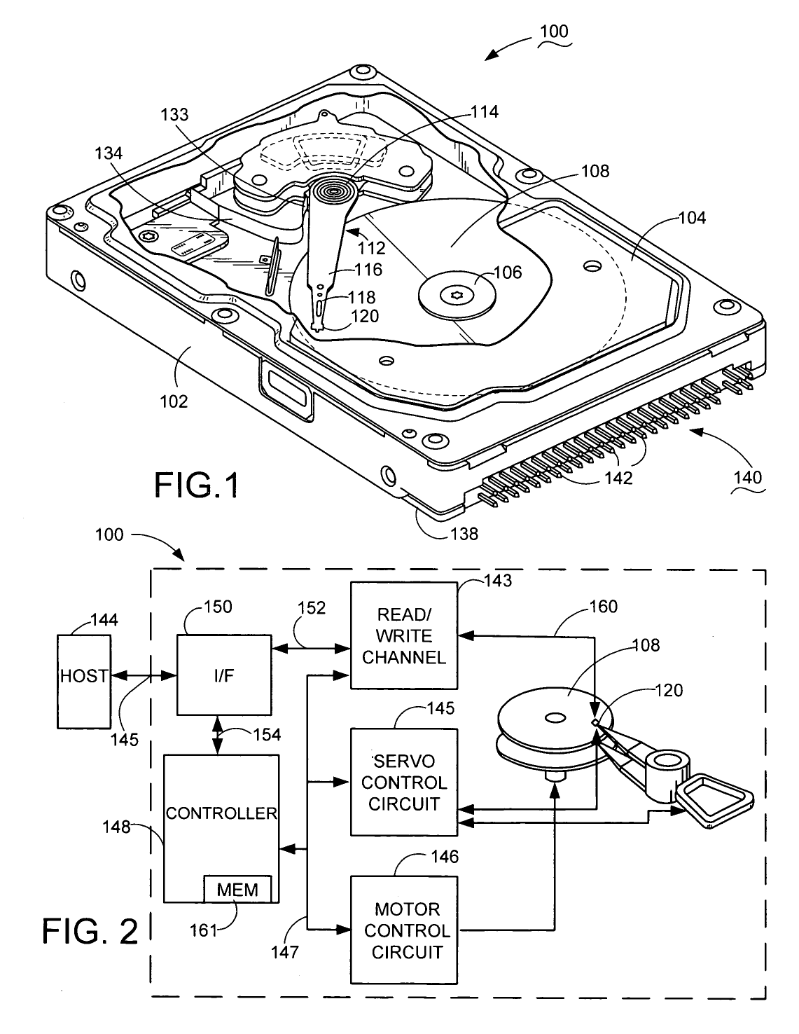

Referring to the drawings in general, and more particularly to FIG. 1 that shows an isometric view of a data storage device 100 constructed in accordance with embodiments of the present invention. The device 100 preferably includes a base 102 and a cover 104 (partially cutaway), which together provide a housing for a number of components. The components include a motor to which a clamp 106 is attached for fixing one or more storage mediums 108 in rotation therewith. Adjacent the storage medium 108 is an actuator assembly 112 that pivots around a bearing assembly 114. The actuator assembly 112 includes an actuator arm 116 supporting a load arm 118 that, in turn, supports a head 120 (or “transducer”) at a distal end thereof in a data transfer relationship with the adjacent storage medium 108. Each storage medium 108 can be divided into data tracks, and the head 120 is positioned to retrieve data from and store data to the tracks.

To provide the requisite electrical conduction paths between the head 120 and device 100 control circuitry, the head 120 advantageously has a flex circuit (shown below) that is routed on the actuator assembly 112 from the head 120, along the load arm assembly 118 and the actuator arm 116, and to a circuit portion 133 that is supported by a proximal end (sometimes referred to as “E block”) of the actuator assembly 112 by steps for soldering the circuits together in electrical connection. The circuit portion 133 connects the head 120 flex circuit to another flex circuit 134 which passes through the base 102 to a printed circuit board (PCB) 138. An electrical connector 140 attached to the PCB 138 has a plurality of contacts 142 for connecting the device 100 to a mating connector (not shown), such as for placing the device 100 in communication with external control circuitry.

The present embodiments contemplate an apparatus and associated method for electrically connecting these circuits together in a high speed manufacturing environment. Generally, the flex circuit leads are aligned with contacts of the circuit portion 133. This alignment can take place adjacent a built-up pad of solder material, which exists in the solid phase at ambient temperature. A heated soldering tip then pressingly engages against the circuit contacts and the solder material, melting the solder to encapsulate both circuit contacts. When the soldering tip is withdrawn the circuits are thus physically joined by being encapsulated together within the solidified solder. They are also electrically joined in that the solder material is electrically conductive. In alternative equivalent embodiments the soldering material can be delivered by the machine controlling movement of the soldering tip, such as but not limited to “solder shooter” types of automated soldering machines.

FIG. 2 is a functional block diagram illustrating types of control signals and data transfers that are passed between the device 100 and a remote device, such as with a host 144 via a bus 145. The device 100 generally has a read/write channel 143, a servo control circuit 145, and a motor control circuit 146, all connected by a control bus 147 to a controller 148. An interface circuit 150 is connected to the read/write channel 143 by bus 152 and to the controller 148 by bus 154. The interface circuit 150 serves as a communications interface between the device 100 and the host device (or other remote device such as a network server). Generally, in response to an access command from the host 144 and received by the controller 148 from the interface 150, the controller 148 controls the flow of data to and from the storage medium 108. The read/write channel 143, in turn, provides store and retrieve signals to the head 120 in order to store data to the storage medium 108 and retrieve data from the storage medium 108. A buffer 161 exists under the control of the controller 148 in order to temporarily store data associated with host 144 access commands with the storage medium 108. The head 120 can, for example, provide an analog read signal to the read/write channel 143, which in turn converts the analog read signal to digital form and performs the necessary decoding operations to provide data to the interface circuit 150 for output to the host 144.

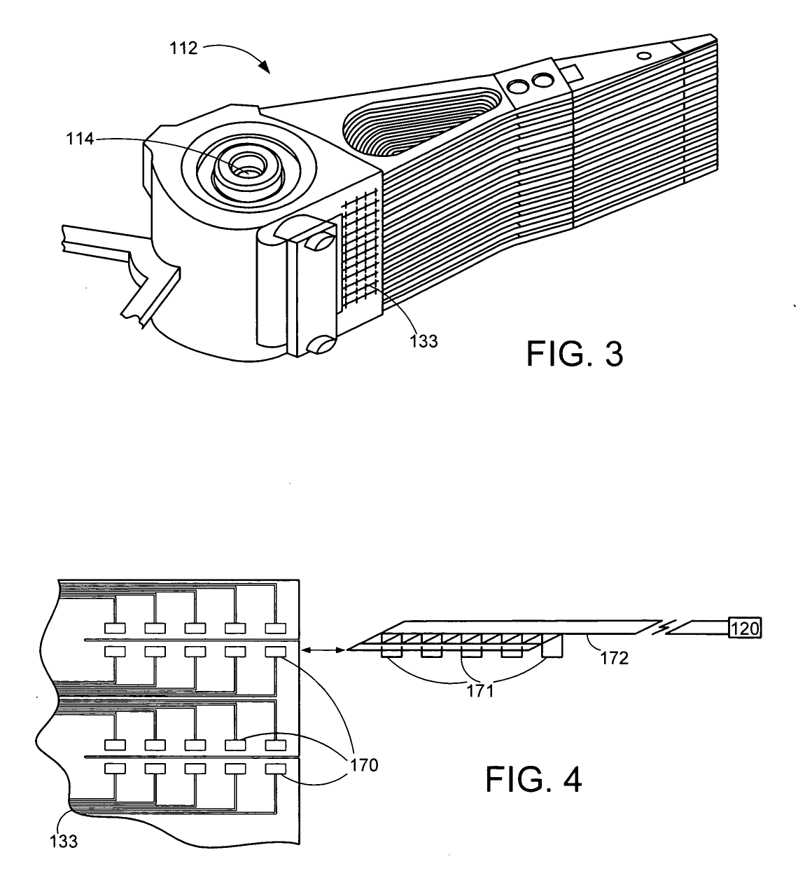

FIG. 3 is an isometric view of the actuator assembly 112 (with the voice coil motor portion removed) that better illustrates the circuit portion 133 that is supported by the E block. This circuit portion 133 is diagrammatically enlarged in FIG. 4 to better illustrate that a number of solder pads 170 are provided for connection to corresponding connectors 171 in the flex circuit 172 portion extending from the head 120.

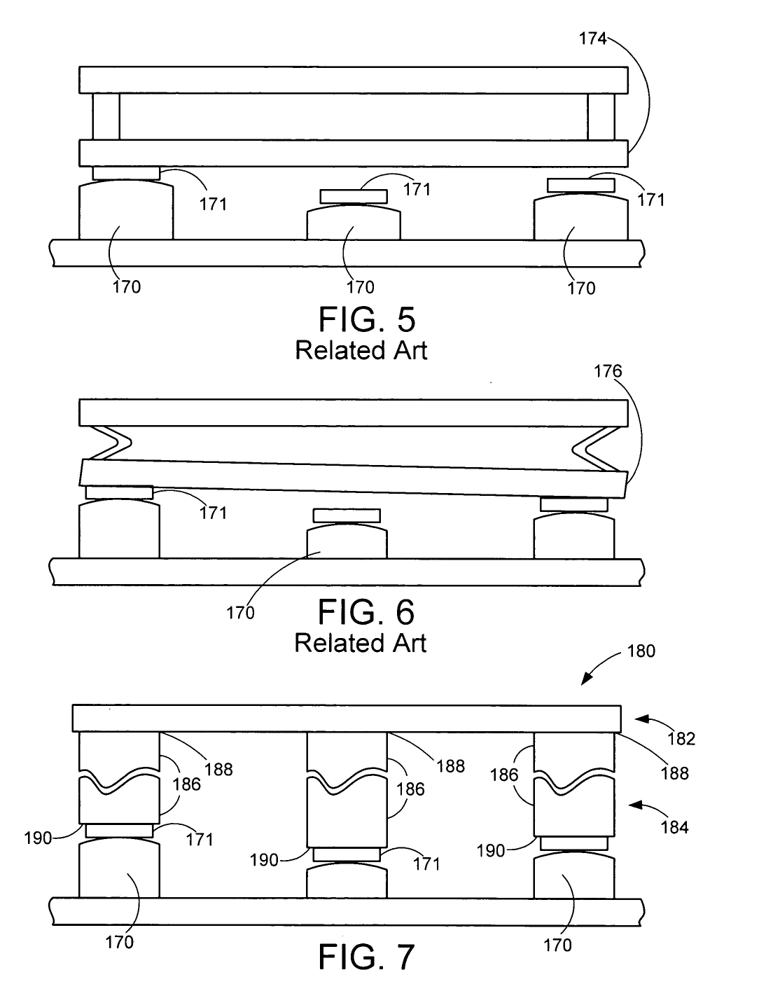

For manufacturability sake it is advantageous to solder a number of the connections together simultaneously rather than one connection at a time. However, normal part-to-part and process variations typically yield solder pads 170 of varying heights. FIGS. 5-7 diagrammatically illustrate three such solder pads 170 wherein, with respect to each other from left to right, there is shown a highest solder pad 170, a lowest solder pad 170, and an in-between solder pad 170. Although the illustrative embodiments of FIGS. 5-7 deal exclusively with variations in solder pad 170 height, it will be understood that other sources of variation are also possible, such as but not limited to misalignment between the soldering tool and the soldering pads 170. Those other types of part-to-part and/or process variations are likewise addressed by the embodiments of the present invention.

FIG. 5 illustrates the problem associated with using a fixed hot bar 174. When the fixed hot bar 174 is lowered to contactingly engage the highest solder pad 170 it does not contactingly engage the other two. The uneven pressure and heat placed on the solder pads 170 can at best produce inconsistency in the quality of the soldered connections, and at worst can result in a solder connection failure.

FIG. 6 illustrates the use of a floating or otherwise compliant hot bar 176. Note that although the compliant hot bar 176 has compensated for the misalignment of the highest solder pad 170 and the in-between solder pad 170, as in the case of FIG. 5 not all the solder pads 170 are contactingly engaged. This can lead to the same problems as described in relation to FIG. 5.

FIG. 7 diagrammatically illustrates a multiple tip soldering tool 180 constructed in accordance with embodiments of the present invention. The multiple tip soldering tool 180 has a conductor 182 that is configured for electrically connecting to an external power supply for generating resistive heat. A segmented hot bar 184 has independent suspensions 186. That is, by “segmented” it is meant that each of the suspensions 186 is independently compressible because the suspensions are noncontactingly disengaged from each other. In other words, the “segmented” hot bar 184 has suspensions that are individually compliant; that is, compliance in one suspension 186 is independent of the compliance of any other suspension 186.

Each suspension 186 depends at a proximal end 188 from the conductor 182 and supports a soldering tip 190 at a distal end. In this way each of the plurality of soldering tips 190 contactingly engages the respective connector 171, regardless of solder pad 170 height variation, or other like variation.

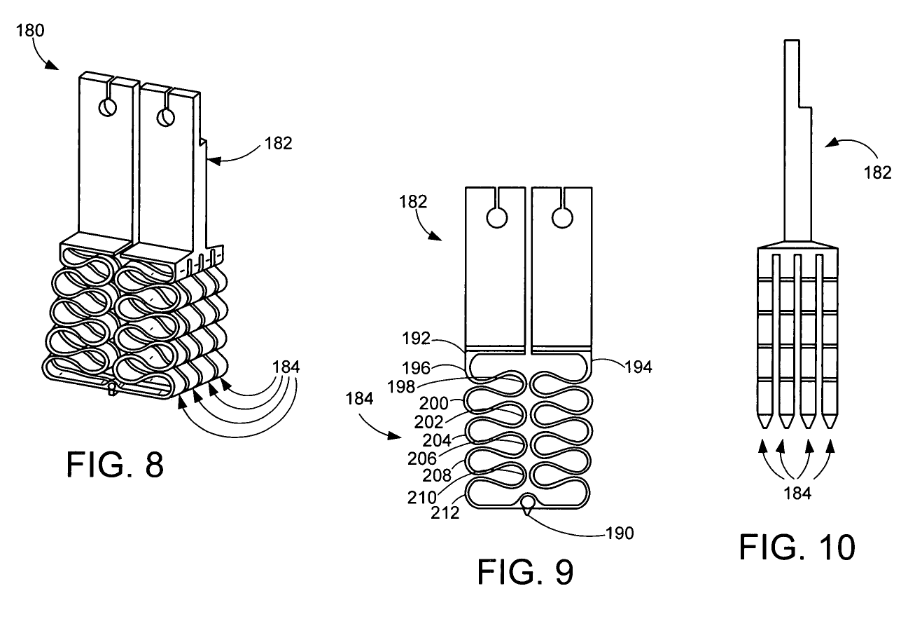

FIGS. 8-10 are isometric, side, and front views, respectively, of a multiple tip soldering tool 180 constructed in accordance with embodiments of the present invention. It will be noted that each suspension 184 has a flexible loop connected at the ends 192, 194 thereof to the conductor 182. A medial portion of the flexible loop supports the soldering tip 190.

The loop is made flexible in these illustrative embodiments by a plurality of arcuate compression features 196, 198, 200, 202, 204, 206, 208, 210, 212 (hereinafter “196-212”) that are formed in a portion of the flexible loop between the end 192 and the soldering tip 190. The compression features 196-212 generally are thin-walled flexible structures with openings directed transversely to a longitudinal axis of the suspension 184. This arrangement makes the compression features compressible in the longitudinal direction by a deflection that narrows the opening. Conversely, the compression features are expandable along the longitudinal direction by widening the opening.

It will be further noted that in order to pack the plurality of compression features 196-212 as densely as possible, it is advantageous to chain them together. That is, in the orientation of FIG. 9 the bottom of the compression feature 198 is connected to the top of the adjacent compression feature 200, and so on. Also, reversing the orientation of adjacent compression features 196-212 makes it possible to pack them more densely. Also, by making the arcuate portions circumscribe an arc with an included angle of more than 180 degrees, it is possible to nest a particular compression feature 196-212 within its adjacent compression features 196-212, further making it possible to pack them more densely.

It will be further noted that the other portion of the flexible loop between the end 194 and the soldering tip 190 can likewise have compression features, and in the illustrative embodiments can be mirror images of the compression features 196-212.

In successful trials of the present embodiments the compression features illustrated in FIGS. 8-10 were rough machined from a block of Haynes 230 Alloy and secondarily manufactured by an electrical discharge machining (EDM) process to produce the eighteen arcuate compression features 196-212. With a wall thickness of 0.100 inches, this arrangement provided for up to about 0.008 inches of compressibility at a preselected soldering tip temperature. Clearly, however, in alternative equivalent embodiments the wall thickness, the material, and the size, shape and number of the compression features can be changed from the illustrative embodiments of FIGS. 8-10 in order to provide more or less compressibility, as particular needs require.

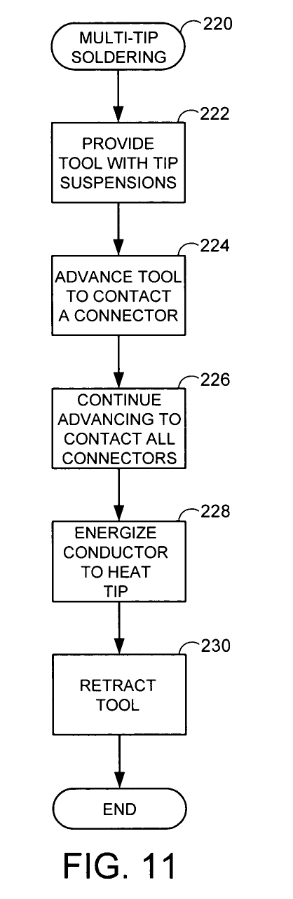

FIG. 11 is a flowchart of illustrative steps for practicing a method 220 of MULT-TIP SOLDERING in accordance with embodiments of the present invention. The method begins in block 222 with providing a multiple tip soldering tool having a segmented hot bar providing a plurality of soldering tips supported by independent suspensions, such as generally illustrated by the tool 180 (FIGS. 8-10). Preferably, the providing step 222 is characterized by each suspension being defined by a flexible loop connected at the ends thereof to a conductor that is attachable to an external power supply, wherein the soldering tip is supported by a medial portion of the flexible loop. A first portion of the flexible loop between the conductor and the soldering tip can have a compression feature that is compressible in a longitudinal direction of the suspension. As discussed above, for maximum compressibility more compression features can be packed into a given length of a suspension by chaining them together, by orienting adjacent ones in opposite orientations, and nesting arcuate features by making them with an included angle of more than 180 degrees. The other portion of the loop preferably has compression features as well, which can be provided in a mirror image to the first portion compression features.

The method 220 continues in block 224 by advancing the tool toward a series of connectors to be soldered, until one of the solder tips contactingly engages a respective one of the connectors. In block 226 the tool continues to advance until all of the soldering tips contactingly engage the respective connectors, made possible at least by a compression of the suspension associated with the first solder tip to make contacting engagement. This complete contacting engagement can be detected in any of numerous ways, such as by monitoring the pressure applied by the tool against the contactor in the contacting engagement, or by monitoring a displacement of the tool as it contactingly engages the connector.

With all tips contactingly engaging the respective connectors, control then passes to block 228 where the conductor portion of the tool is energized to produce resistive heat in the soldering tips. After dwelling for a predetermined time at a predetermined power level, the tool is retracted in block 230 and the method ends.

Some embodiments generally contemplate a method for electrically connecting components of the data storage device 100. The method includes attaching the transducer 120 having the flex circuit 172 to a distal end of the actuator assembly 112. The method also includes attaching the flex circuit 172 to a circuit portion 133 supported by a proximal end of the actuator assembly 112 by steps for soldering the circuits together in electrical connection. For purposes of the present description and meaning of the appended claims, the term “steps for soldering” as expressly described herein means multi-tip soldering with a soldering tool having each soldering tip supported by an independent suspension. This permits contactingly engaging all the plurality of connectors with the soldering tool regardless of part-to-part and process variation, such as but not limited to solder pad 170 height and part fixturing variation.

The term “steps for soldering” expressly does not encompass previous attempted solutions such as the fixed hot bar illustrated in FIG. 5 and the compliant hot bar illustrated in FIG. 6. Those previous solutions yielded problems associated with not being able to contactingly engage all the connectors robustly for soldering, and those problems are solved by the embodiments of the present invention as claimed.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the devices in which they are incorporated or the particular environment in which they are used without departing from the spirit and scope of the present invention.

In addition, although the illustrative embodiments described herein are directed to a data storage system, it will be appreciated by those skilled in the art that the claimed subject matter is not so limited and various other electronic devices can utilize the embodiments of the present invention without departing from the spirit and scope of the claimed invention.

What is claimed is:

1. A multiple tip soldering tool comprising:
a conductor adapted for conducting power from an external supply; and
a segmented hot bar having first and second independent suspensions, each suspension depending at a proximal end from the conductor and conductively supporting a soldering tip at a distal end.

2. The multiple tip soldering tool of claim 1 wherein each suspension comprises a flexible loop connected at the ends thereof to the conductor and supporting the soldering tip at a medial portion thereof.

3. The multiple tip soldering tool of claim 2 wherein a first portion of the flexible loop between one end thereof and the soldering tip comprises a compression feature that is compressible in a longitudinal direction of the suspension.

4. The multiple tip soldering tool of claim 3 wherein the first portion of the flexible loop defines a plurality of compression features in series.

5. The multiple tip soldering tool of claim 4 wherein adjacent compression features are disposed in opposite orientations.

6. The multiple tip soldering tool of claim 5 wherein the compression features comprise arcuate members.

7. The multiple tip soldering tool of claim 6 wherein the arcuate members each circumscribe an arc with an included angle of more than 180 degrees.

8. The multiple tip soldering tool of claim 7 wherein the first portion of the flexible loop comprises nine compression features.

9. The multiple tip soldering tool of claim 3 wherein a second portion of the flexible loop between another end thereof and the soldering tip comprises a compression feature that is compressible in the longitudinal direction of the suspension.

10. The multiple tip soldering tool of claim 9 wherein the second portion of the flexible loop is a mirror image of the first portion of the flexible loop.

11. A method comprising:
providing a multiple tip soldering tool having a segmented hot bar providing a plurality of soldering tips supported by independent suspensions;
advancing the multiple tip soldering tool toward a plurality of connectors until one of the soldering tips contacts a respective connector;
continuing to advance the multiple tip soldering tool until all of the soldering tips contact the respective connectors.

12. The method of claim 11 wherein the providing step is characterized by each suspension being defined by a flexible loop connected at the ends thereof to a conductor that is attachable to an external power supply, wherein the soldering tip is supported by a medial portion of the flexible loop.

13. The method of claim 12 wherein the providing step is characterized by a first portion of the flexible loop between one end thereof and the soldering tip having a compression feature that is compressible in a longitudinal direction of the suspension.

14. The method of claim 13 wherein the providing step is characterized by the first portion of the flexible loop having a plurality of compression features chained together.

15. The method of claim 14 wherein the providing step is characterized by adjacent compression features being connected together in opposite orientations.

16. The method of claim 15 wherein the providing step is characterized by the compression features defining arcuate members.

17. The method of claim 16 wherein the providing step is characterized by the arcuate members each circumscribing an arc with an included angle of more than 180 degrees.

18. The method of claim 13 wherein the providing step is characterized by a second portion of the flexible loop between another end thereof and the soldering tip having a compression feature that is compressible in the longitudinal direction of the suspension.

19. The method of claim 18 wherein the providing step is characterized by the second portion of the flexible loop being a mirror image of the first portion of the flexible loop.

20. A method for electrically connecting components of a data storage device comprising:
attaching a transducer having a flex circuit to a distal end of an actuator; and
connecting the flex circuit to a circuit portion supported by a proximal end of the actuator by steps for soldering the circuits together in electrical connection.
